(19) United States
(12) Patent Application Publication
(10) Pub. No.: US 2019/0053521 A1
(43) Pub. Date: Feb. 21, 2019

(54) METHOD AND DEVICE FOR COOKING CEREAL GRAINS

(71) Applicant: KONINKLIJKE PHILIPS N.V., Eindhoven (NL)

(72) Inventors: CONG TIAN, EINDHOVEN (NL); SHUXIAO ZHENG, EINDHOVEN (NL); DONGHAI YU, EINDHOVEN (NL); YANYAN WANG, EINDHOVEN (NL)

(21) Appl. No.: 15/768,844

(22) PCT Filed: Nov. 4, 2016
(86) PCT No.: PCT/EP2016/076655

§ 371 Date: Apr. 17, 2018

(30) Foreign Application Priority Data
Nov. 5, 2015 (CN) PCT/CN2015/093865
Dec. 16, 2015 (EP) 15200324.0

(51) Int. Cl. A23L 7/183; A23L 5/10; A23L 33/20; A23P 30/38; A47J 27/00; A47J 27/04; A47J 36/32

(52) U.S. Cl. CPC A23L 7/183; A23L 5/13; A23L 33/20; A23P 30/38; A23V 2002/00; A47J 27/04; A47J 36/32; A47J 2027/043; A47J 27/004

(57) ABSTRACT

The present application relates to a method of cooking cereal grains comprising a first step (S1) of subjecting an initial volume of cereal grains (3) to hot air in a vessel (2) having air temperature between 150 to 250 degrees Centrigrade for between 30 to 180 second; and a second step (S2) of subjecting the expanded cereal grains (3) to boiling water and/or steam. The second step (S2) is performed subsequent to the first step (S1) whilst the expanded cereal grains remain in the vessel (2). A device for cooking cereal grains (3) is also disclosed. The invention increases the overall volume of the cooked cereal grains compared to conventional cooking methods which results in cereal grains having a lower energy density.

### FIELD OF THE INVENTION

The present invention relates to a method of cooking cereal grains and to a cooking device for carrying out the method of the invention.

### BACKGROUND OF THE INVENTION

Increased weight and obesity is becoming more prevalent and is often a primary contributor to poor health. Weight problems are usually the result of excess energy intake. Whilst one solution to this may be to follow an energy restriction diet, many people find it difficult to follow a diet plan longer term as it necessarily requires them to consume less food.

An alternative solution that enables an overweight person to reduce their energy intake is to decrease the energy density of a particular foodstuff by increasing its volume. A person will then become satiated after having consumed a smaller amount of that particular foodstuff compared to the amount that they would have normally consumed at its usual volume and energy density. The energy density of a foodstuff may be defined as the amount of energy per volume of food (KJ/ml).

Cereal grains, such as rice, are a very commonly consumed staple food which accounts for more than 50% of a person's daily energy intake in some countries.

Known methods of decreasing the energy density of cereal grains require further improvements to efficiently address the obesity problem.

### SUMMARY OF THE INVENTION

It is an object of the invention to provide a method for cooking cereal grains to increase their volume and thereby lower their energy density.

The invention is defined by the independent claims. The dependent claims define advantageous embodiments.

According to the present invention, there is provided a method of cooking cereal grains comprising a first step of exposing an initial volume of cereal grains in a vessel to hot air having air temperature between 150 to 250 degrees Centrigrade for between 30 to 180 seconds; and a second step of exposing the expanded cereal grains to boiling water or steam; and wherein the second step is performed subsequent to the first step whilst the expanded cereal grains remain in the vessel.

This method has the beneficial effect of reducing the amount of cereal grain that a person needs to consume in order to satiate their appetite and so contribute to the control of a person's weight.

A temperature within this range has been found to be optimum for effective expansion of most types or varieties of cereal grain taking into account different grain characteristics, types and moisture content.

By carrying out both steps using the same cooking device, and without having to transfer the cereal grain from one vessel to another, the method is carried out easily and the cereal grain is cooked more quickly and thoroughly with little or no time to cool between steps, thereby maintaining efficiency and simplifying the cooking method.

If the method is carried out using a cooking device comprising a heater and the vessel to receive the initial volume of cereal grains to be cooked, then the method preferably includes the step of operating the heater to pre-heat the vessel prior to placing the initial volume of cereal grains in the vessel to perform the first step.

By heating the vessel before placing the initial volume of cereal grains within it, thermal efficiency is improved and expansion of the cereal grains occurs more rapidly. Pre-heating the vessel can also prevent the cereal grain from acquiring a dark appearance during the first step.

If the cooking device includes a reservoir to contain water, the method preferably includes the step of providing water from a reservoir for heating by the heater during the second step.

By maintaining water in a reservoir within the device, water can be supplied to the heater quickly and thereby enable the second step to be carried out immediately upon completion of the first step, thereby minimising cooking time and simplifying the process.

If the vessel is fluid-permeable, then the step of operating the device advantageously comprises allowing water that flows from the reservoir for heating by the heater through the vessel and the expanded cereal grains of increased volume contained in the vessel.

By allowing the water to flow from the reservoir and through the vessel, the expanded cereal grains are soaked in water at the start of the second step prior to being exposed to steam. By soaking the grains in this way, the grains reach the starch gelatinization temperature quickly and so cooking time is reduced.

If the vessel is fluid-impermeable, the step of operating the device advantageously comprises allowing water that flows from the reservoir for heating by the heater into the vessel to submerge at least some or all of the cereal grains of increased volume contained in the vessel.

The second step may comprise subjecting the cereal grains to water having a temperature below boiling point upon commencement of the second step, and heating the water to boiling point during performance of the second step.

In a preferred embodiment, the second step may comprise subjecting the cereal grains to water that has been pre-heated to between 60 and 80 degrees Centigrade upon commencement of the second step.

The second step of subjecting the cereal grains to boiling water and/or steam may comprise initially subjecting them to water at any temperature including, for example, ambient temperature or 25 degrees Centigrade. The water is then heated to boiling point in order to cook the grains. However, the water may initially be pre-heated so that it is at an elevated temperature prior to being combined with the cereal grains or fed to the heater. For example, the water may initially be pre-heated to a temperature between 60 and 80 degrees Centigrade. The heater used to heat the cereal grains during performance of the first step S1 may also be used to pre-heat the water for use in the second step S2 so that maximum efficiency and reduced cooking time is achieved.

According to the present invention, there is also provided a device for cooking cereal grains. The device comprises a vessel to receive an initial volume of cereal grains, the vessel being located in a chamber, a heater for heating air and, a controller, the controller being configured, in a first step (S1), to control the heater to expose the initial volume of cereal grains to heated air having a temperature adapted to cause the cereal grains to expand above their initial volume, a reservoir to receive water, the controller being further configured, in a second step, to trigger the supply of water from the reservoir into the chamber for heating by the heater to expose the increased volume of cereal grains to heated water and/or steam. The steam may be resulting from the heated water or provide separately by a steam provider/generator.

Preferably, the vessel is located in an elevated position in the chamber.

The vessel advantageously comprises a fluid-permeable mesh so that hot air may circulate through the mesh and heat the cereal grains more evenly resulting in more consistent and even expansion of all or the majority of the cereal grains contained in the mesh. By providing a permeable mesh, water may also flow through it to soak the expanded volume of cereal grains as it flows into the chamber from the reservoir.

Preferably, the device comprises a fan or an air blower for circulating heated air in the chamber. The inner walls of the chamber defines a food receiving space, the chamber comprises an air circulation channel formed between the outer wall of the vessle and inner wall of the chamber for circulating air in and out the food receiving space of the vessle via said circulation channel.

In an alternate embodiment, the vessel may be fluid impermeable so that water flows into the vessel from the reservoir to submerge the expanded volume of cereal grains in the second step.

The device preferably comprises a bypass valve to enable at least some of the water to flow directly from the reservoir into the chamber without passing into the vessel.

Preferably, the reservoir surrounds the chamber and the heater is positioned so that water contained in the reservoir is pre-heated by the heater prior to flowing from the reservoir.

By positioning the heater so that it pre-heats the water in the reservoir during the first step, the water is turned to steam more rapidly when it is fed to the heater in the second step.

These and other aspects of the invention will be apparent from and elucidated with reference to the embodiments described hereinafter.

### BRIEF DESCRIPTION OF THE DRAWINGS

Embodiments of the invention will now be described, by way of example only, with reference to the accompanying drawings, in which:

FIG. 1 is a flowchart to illustrate the steps of the cooking method according to an embodiment of the present invention; and

FIG. 2A is a cross-sectional side elevation of a cooking device according to an embodiment of the invention, which can be used for cooking cereal grains according to the method of the invention. The Figure shows the device during performance of the first step of the method of the invention;

FIG. 2B is the same view as FIG. 2A but showing the device during performance of the second step of the method of the invention; and

FIG. 2C is a cross-sectional side elevation of a cooking device according to another embodiment of the invention, which can be used for cooking cereal grains according to the method of the invention. The Figure shows the device during performance of the first step of the method of the invention.

### DETAILED DESCRIPTION OF THE EMBODIMENTS

Embodiments of the invention provide a method of cooking cereal grains. The method includes first and second steps S1, S2. The first step S1 involves subjecting an initial volume of cereal grains to hot air having air temperature adapted to cause the cereal grains to expand above their initial volume. The second step S2 involves subjecting the expanded cereal grains to boiling water and/or steam.

The first step S1 is performed for the purpose of causing the cereal grains to expand. Expansion of cereal grains is also referred to as ‘puffing’ or ‘popping’ and involves heating the cereal grains in hot air of low moisture content to create micro-bubbles within individual cereal grains which expand and then burst out of the grain. Whilst the air may be completely dry, it also includes the heating of cereal grain in ambient air where the ambient air is of low moisture content. Fundamentally, the cereal grain is heated in the absence of any added liquid or moisture other than that present in ambient conditions and any residual moisture contained within the cereal grains themselves. Note that even if the residual moisture in the cereal grains is very low, expansion of the cereal grains is still possible.

Expansion of cereal grains occurs due to a reaction between starch and moisture when the cereal grains are heated. Although cereal grains contain limited moisture (usually between 10 and 20%), the moisture content of individual grains is still sufficient to cause them to expand as a result of the internal moisture within each grain turning to vapour when heated to a sufficiently high temperature in dry conditions for a short period of time. An increase in pressure within the grain, or thermal gradient across the grain, as a result of conversion of the residual moisture into super-heated vapour causes the grain to suddenly expand breaking its outer skin. The pressure builds up within the grain until an outer part or surface of the grain can no longer contain the pressure and it eventually ‘pops’ or bursts.

Generally, the expansion effect is more prevalent with a cereal grain that has a shell in the form of its hull or husk, or otherwise has a harder outer skin or surface relative to its inner core. the skin or shell initially traps the vapour within the grain before suddenly releasing it as the hull or husk bursts open. However, a pressure differential can be generated in many different types of grain and that the presence of a hull or husk is not essential to cause an internal pressure increase as a result of converting residual moisture within individual grains to vapour and the skin of a cereal grain can be sufficient to cause a pressure build up as a result of heating under dry or ambient conditions.

Any grain that has a slightly harder out layer can expand according to this process, even though the effect may be smaller than with grain that retains its hull or husk. It is also possible to cause grains of corn to expand in this way. Corn has a soft outer membrane which is sufficient to cause a pressure build up within the grain as a result of the moisture contained within it turning to steam prior to bursting.

It has also been established that grains that do not initially have a harder outer layer will also pop and expand as a result of heating in air. For example, polished white rice, which is not generally considered to possess a harder outside layer, will also expand as a result of heating in air. The popping or expansion effect is achieved due to the water molecules existing close to the surface of each rice grain evaporating quickly which results in an outer layer of the grain becoming relatively dry and hard whilst water molecules within the core of the rice grain are at the same time restricted from evaporating due to the dry, outer layer. The outer layer effectively becomes harder than the core and this generates a pressure imbalance across the rice grain. The pressure builds up until the outer layer can no longer contain the pressure and the grain bursts. Other cereal grains susceptible to expansion are wheat and sorghum.

In the first step S1 of the method according to the invention, the initial volume of cereal grain is preferably heated in air having a temperature in the range of 150˜250 C, and for a given period of time which is most preferably between 30˜180 seconds. It will be apparent to a skilled person that a selected temperature and given heating time will depend on a number of variable factors such as the type of cereal grain being cooked and its initial weight. In particular, factors which influence the expansion of cereal grains can include the season, varietal difference, grain characteristics and moisture content.

It will also be understood that heating of the air used to heat the cereal grain can be carried out using a number of different heating methods including electromagnetic, microwave, IR, hot-air blower or by using a wire heater.

When the first step S1 is complete, the cereal grains of expanded volume are subsequently subjected to a second step S2 of high moisture heating, such as subjecting them to boiling water or subjecting them to steam for a given period of time, typically in the range of 15˜30 minutes. A combination of subjecting the cereal grains to boiling water and steam may also be employed. Preferably, the second step S2 is initiated immediately after the first step has been completed, although a certain time period may be allowed to elapse between the first S1 and second steps S2. The boiling and/or steaming of the expanded cereal grains improves their texture, taste and mouth-feel compared to cereal grains which have been expanded but not subsequently subjected to steam or boiling water.

Another advantage is that by combining the first step S1 (popping or expanding) followed by the second step S2 (steaming and/or boiling), the resultant volume of cereal grain is greater compared with the volume of cereal grain that has been prepared using only one of the steps S1 or S2 alone.

By way of example, an initial volume (24 ml) of brown rice (20 gram) was cooked using both steps S1 and S2 and the volume of rice determined between each step. After the first (popping or expanding) step S1 (popping temperature at 200 C for 1 minute), the volume of the rice was found to be approximately 44 ml. After the second (steaming and/or boiling) step S2 (popped rice is immersed in 20 ml water with initial temperature at 80 C and steaming for 30 minutes), the volume of the rice was found to be approximately 73 ml. An initial volume (24 ml) of rice was also cooked using the second step S2 only (i.e. immersed in 20 ml water with initial temperature at 80 C for 60 minutes, and the resultant volume was found to be approximately 57 ml. The results demonstrate that a combination of the first step S1 followed by the second step S2 yields a significant volume increase compared to using only one of the steps S1 or S2 alone.

If the cereal grains are subjected to steam in the second Step S2, then they can be soaked with water prior to exposure to the steam. The cereal grains can also be contained in a perforated vessel, such as a sieve or the like, so that the water can be circulated through them during the second step S2

It is noted that the process described above can be applied to any type of cereal grain, including white or brown rice, corn or sorghum, although some types of cereal grain will pop or expand more readily than others. The primary factor that determines the ability of the grain to expand is its moisture content and the ability for pressure to build up within the grain.

In performance of the second step (S2), the water may initially be at room or ambient temperature, then heated until reaching boiling point, and then subject the expanded cereal grains to steam generated by boiling water.

If the expanded cereal grains are immersed in the water, then the water can be heated to boiling point to cook the cereal grain. Heating of the water in which the grains are immersed can be by exposing the vessel to steam or by heating it by other known heating techniques. Furthermore, the water can initially be at an elevated temperature prior to commencement of the second step (S2). For example, the water may be pre-heated to between 60 and 80 degrees Centigrade. The heater which is used to heat the air during performance of the first step (S1) can also simultaneously pre-heat the water for subsequent use in performance of the second step (S2).

By way of an example, the expansion effect on both rice and brown rice has been examined and this will now be described in more detail.

In the first Step S1, a stainless steel bowl-shaped mesh was placed in a device capable of generating heat under ambient conditions, in this case, an air-based fryer device using circulation of hot air to cook food ingredients. The device was activated and the air temperature within it was allowed to reach 200 degrees Centigrade. At this point, 20 grams of rice was placed in the mesh and heating was continued for a period of time. It was found that a period of 3 minutes was sufficient to cause effective expansion of the majority of the white rice grains, whilst a shorter time of approximately 1 minute was required for the effective expansion of the majority of the brown rice grains.

Following step S1, the expanded rice was transferred into a fluid-impermeable bowl in a steam cooker, and hot water at a temperature of 80 degrees Centrigrade was added to immerse the expanded rice. The water and rice was then heated under steam until the water boiled for a period of 20 minutes for white rice and, 30 minutes for brown rice.

The table below shows (non limitative) examples about how the volume of white and brown rice increased as a result of carrying out the method described above. As a benchmark, the same quantity of rice was also cooked using a conventional cooking process. The percentage increase in volume (ml) that was achieved as a result of following the cooking method of the invention is provided in the 3^{rd} column. As can be seen from the table, compared to traditionally cooked white rice (WR) (i.e. in boiling water for 30 minutes cooking time), the use of the cooking method according to the invention results in an increase of approximately 17% in volume of the cooked rice and reduces the cooking time by ⅓rd (i.e. 20 minutes for the method according to the invention vs 30 minutes for conventional white rice cooking method). Similarly, in relation to brown rice (BR), the cooking method of the invention resulted in an increase in volume of approximately 29% compared to traditionally cooked brown rice (i.e. in boiling water, for 60 minutes cooking time), and reduces the cooking time by half (i.e. 30 minutes for the method according to the invention vs 60 minutes for conventional brown rice cooking method). Percentage increases in volume of this magnitude are detectable visually and as a result of comparing a bowl of rice cooked using the traditional cooking method side-by-side with a bowl of rice cooked using the method of the invention.

| | Volume | Volume increase |
|---|---|---|
| | (ml) ± SD | (%) ± SD |
| Benchmark 1: 20 g of WR cooked in | 55.0 ± 1.41 | 16.7 ± 5.70(n = 4) |
| a conventional way | | |
| Sample 1: 20 g of WR cooked | 64.3 ± 4.35 | |
| according to the method of the | | |
| invention | | |
| Benchmark 2: 20 g of WR cooked in | 56.8 ± 3.11 | 28.7 ± 7.88(n = 5) |
| a conventional way | | |
| Sample 2: 20 g of WR cooked | 73.0 ± 4.12 | |
| according to the method of the | | |
| invention | | |

Whilst the cooking method may be carried out using separate cooking devices for each of the first and second method steps S1, S2, as in the specific example described above, in a preferred embodiment the method is performed using a single cooking device according to the invention which enables both steps S1 and S2 to be carried out sequentially without having to transfer the cereal grain from one device to another.

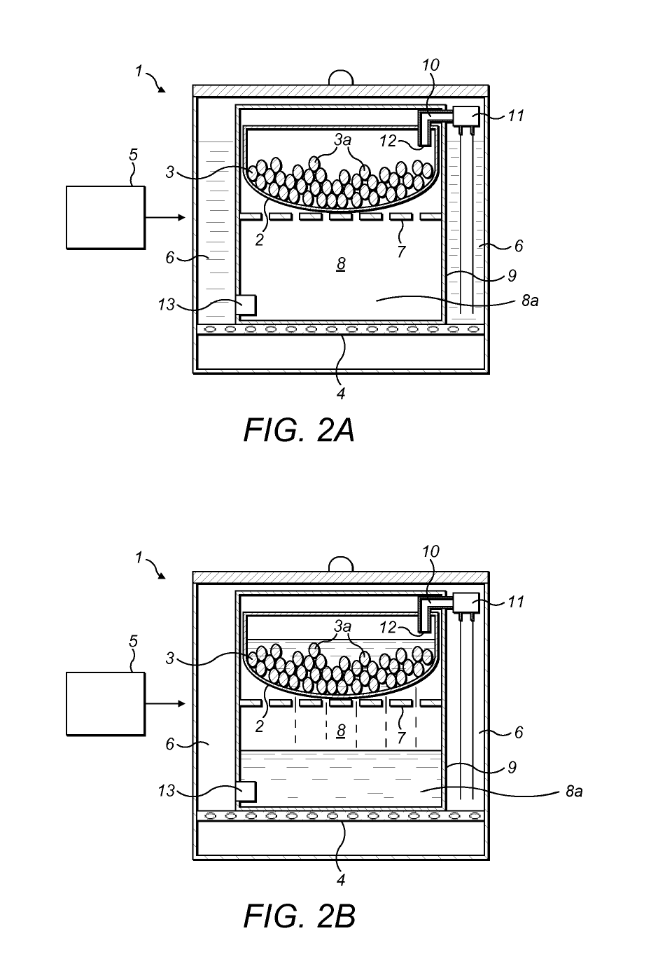

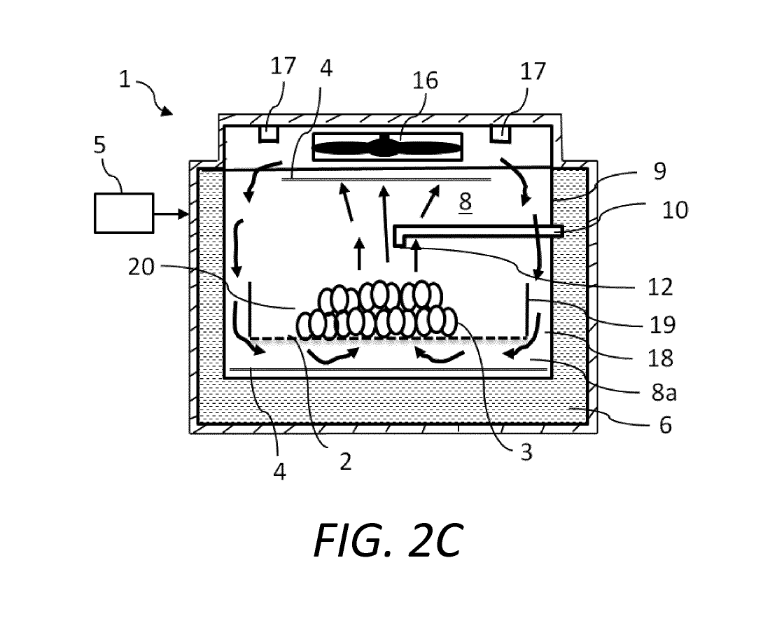

An embodiment of a cooking device 1 for cooking cereal grains according to the method of the invention is shown in FIGS. 2A, 2B and 2C.

The cooking device 1 could be one of the following: air-based fryer with steam function, steam oven, etc.

The cooking device 1 comprises a vessel 2 to receive an initial volume of cereal grains 3 to be cooked, a heater 4 for heating the air within the device and, a controller 5 to control the heater 4 in performance of the first step S1 to subject the initial volume of cereal grains 3 to air which has been heated sufficiently to cause the cereal grains 3 to expand above their initial volume. The device includes a reservoir 6 to receive water. The controller 5 is configured, in performance of the second step S2, to trigger the supply of water from the reservoir 6 for heating by the heater 4, so as to subject the increased volume of cereal grains 3 to boiling water and/or steam. In step S2, the increased volume of cereal grains is subjected to steam and/or immersed in boiling water for a given period of time that depends on a number of factors such as a desired texture and/or sensory feel when being consumed (or more subjective users' criteria), and also depends on the heating efficiency of the device and the amount of grain being cooked. For sake of clarity, the connexions between the controller 5 and the various elements under the control of the controller 5 are schematically illustrated by the arrow at the output of the controller 5.

The vessel 2 is located in an elevated position within a chamber 8 of the device, for example by resting on a support 7, which may also be a filter to prevent any scale from reaching the cereal grains contained in the vessel 2 as a result of the heating process. Steam and liquid water may pass through the filter 7. The chamber 8 has a compartment 8a located below the filter 7 to receive water from the reservoir 6 for conversion into steam during the second step S2. For example, the reservoir 6 extends around the periphery of the chamber 8 and the vessel 2. The reservoir 6 and the chamber 8 can for example be separated from each other by an internal dividing wall 9.

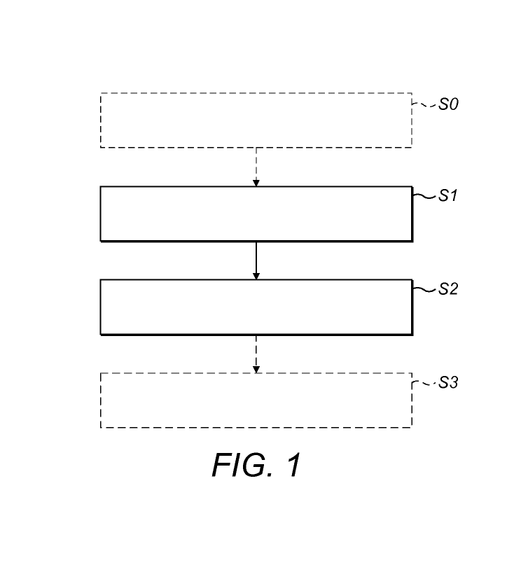

FIG. 2A shows a cross-sectional side elevation of the cooking device 1 as used in the performance of the first step (S1). Prior to initial use, the reservoir 6 is preferably filled with water, either from a dispenser or manually by a user. Optionally, the controller 5 is then used to activate the heater 4 to pre-heat the air within the chamber 8, as well as to heat the vessel 2 in a preliminary heating step (indicated by S0 in the flow chart of FIG. 1). Although pre-heating is not essential, expansion of the cereal grain 3 will happen rapidly following placement of a certain initial volume of cereal grain 3 in the vessel 2 if the air, and the vessel 2, is pre-heated.

As explained above in connection with the method of the invention, the cereal grains are heated in air containing only ambient moisture levels and without any additional moisture or fluid being introduced into the vessel 2 together with the initial volume of cereal grain 3. The first step S1 is performed for a given time period, dependent on the type or variety of cereal grains, and the size of the initial volume. A skilled person may appreciate when the first step S1 is complete from a visual inspection of the cereal grains during fulfillment of the first step S1. Most of the cereal grains will expand rapidly and can be identified relative to those grains which are yet to expand and, when the majority of the grains have expanded.

Although not essential, in addition to heating the air within the chamber 8, the heater 4 extends laterally beyond the chamber 8 and beneath the reservoir 6. If the heater 4 and the reservoir 6 are not insulated from each other, then the heater 4 can be used to pre-heat the water contained in the reservoir 6 at the same time as heating the air in the inner compartment 8 during the first step S1. In a preferred embodiment, the water in reservoir 6 is pre-heated to a temperature of between 60 and 80 degrees Centigrade prior to commencement of the second step S2 (i.e. prior water being transferred to the chamber 8).

Once the first step S1 is complete and the initial volume of cereal grains has expanded to a new and larger volume, the controller 5 can be operated manually or automatically in accordance with a pre-set program so that water will flow along a passage 10 as a result of operation of a pump 11, into the chamber 8. An outlet 12 from the passage 10 is preferably positioned so that water passes into the vessel 2.

In a preferred embodiment, the vessel 2 comprises a fluid-permeable wall (at least the bottom of the vessel 2 comprises fluid-permeable wall). For example, the vessel 2 comprises a fluid-permeable bottom part made of a mesh (like a sieve), or a plurality of holes, to allow water received from the reservoir 6 passing through the fluid-permeable bottom part and dripping down into chamber 8 (as illustrated on FIG. 2B) for subsequent conversion into steam by the heater 4.

It is noted that the use of a fluid-permeable bottom part for the vessel 2 also ensures a more even heating with hot air of all the cereal grains in the vessel 2 during the first step S1.

The expanded cereal grains in the vessel 2 are then soaked in the (pre-heated) hot/boiling water received from the reservoir 6 and passing in the vessel 2.

In an alternative embodiment, the vessel 2 comprises a fluid-impermeable wall. This allows water from the outlet 12 filling the vessel 2, so that the expanded cereal grains 3 are at least partially submerged in the water. In that situation, heat from the heater 4 heats the water and the cereal grains 3. As indicated above, the water is preferably heated to boiling point in performance of the second step S2.

In another preferred embodiment, part of the water in the reservoir 6 is pumped into the vessel 2, and part of the water in the reservoir 6 is passed directly into the inner compartment 8a via a bypass valve 13. This allows performing step S2 while exposing cereal grains to both heated water and steam.

It will be appreciated that the volume of water pumped into the chamber 8 and the inner compartment 8a may be varied dependent upon the type and quantity of cereal grain 3.

In another preferred embodiment, as shown in FIG. 2C, the cooking device 1 do not have a support 7. The chamber 8 has an upper portion and a lower portion, the vessel 2 is supported on the lower portion of chamber and the vessel 2 is releaseable from the chamber 8, for example, the vessel 2 is a drawer type vessel which can be inserted into the lower portion of the chamber 2 for cooking and can be pulled out from the the chamber 2 to enable the providing of the food ingredients and access to food after cooking. The chamber 8 may also comprises an upper lid hinged with the chamber 8, the upper lid can be openned for receiving the food ingredients. The chamber 8 may also comprises an door at the front side of the chamber 8 to enable the providing the food ingredients.

The device 1 may further comprises a fan 16 (or an air blower) for circulating a high speed flow of hot air around and through the food ingredients (cereal grains) received in the vessel 2. The vessle 2 comprises a fluid-permeable bottom, i.e. a meshed bottom.

The device 1 also comprises an air inlet 17 and air outlet (not shown in the figures). The fan, the air inlet 17 and the air outlet may be arranged such that the fan can circulate a (high speed) flow of hot air essentially vertically up or down through a central portion of the vessel 2 and back along an interior periphery of the chamber 8. For example, the fan 16 is located at the upper portion of the chamber, the air inlet 17 may be positioned at the top of the device, while the air outlet may be at the back side of the device. The heated air flows around the vessel 2 in a circulation channel formed between the vessel 2 and the chamber 8. In this example, the inner wall of the vessel 2 defines a food receiving space 20. Part of the air circulation channel 18 is formed between the outer wall of the vessel 2 and inner wall of the chamber 8 for circulating air in and out the food receiving space 20 of the vessel 2 via said circulation channel 18. The whole air circulation channel from the fan to the food ingredient is depicted by arrowed lines in FIG. 2C.

Preferably, the fan 16 (or air blower) is located at the upper portion of the chamber. The heater 4 may be arranged at the upper portion of the chamber or at the lower portion of the chamber, it may also be arranged at the side wall of the chamber.

With this device 1, the step S1 may be implemented more quickly and evenly with the circulated hot air flow.

Similar with aforementioned examples in FIG. 2A and FIG. 2B, once the first step S1 is complete and the initial volume of cereal grains has expanded to a new and larger volume, the controller 5 can be operated manually or automatically in accordance with a pre-set program so that water will flow along a passage 10 as a result of operation of a pump 11, into the chamber 8. The water may submerge or at least partially submerged the cereal grains of increased volume contained in the vessel 2. In that situation, heat from the heater 4 heats the water and the cereal grains 3. As indicated above, the water is preferably heated to boiling point in performance of the second step S2.

Alternatively, the water may pass through the expanded cereal grains and received by the chamber 8, heat from the heater 4 turns the water into steam and the expanded cereal grains is subjecting to the steam in performance of the second step S2.

Alternatively, steam may be generated outside the chamber, by means of a separate steam generator having its own heating means; this steam may then be supplied into the chamber.

The temperature of the water pumped into the inner compartment 8 may also be controlled. To this end, the cooking device 1 preferably includes a temperature sensor (not shown) for this purpose. For example, a temperature sensor is disposed into the passage 10 or in the inner compartment 8, and the method includes an optional third step S3 of detecting the temperature of the water being pumped from the reservoir 6 into the inner compartment 8 using the temperature sensor. According to this method, a signal indicative of the detected temperature may be fed back to the controller 5 and the controller 5 may then deactivate the pump 11 and/or control the heater 4 if the temperature of the water is detected as being outside a predetermined range (to avoid over-heating).

In a preferred embodiment, the temperature of the water pumped into the inner compartment 8 is equivalent, or close, to the starch gelatinization temperature of the cereal grain 3 in the vessel 2.

Starch gelatinization is the process of breaking down the intermolecular bonds of starch molecules in the presence of water and heat. Penetration of water alters the starch granule structure and causes swelling.

For rice, the starch gelatinization temperature is typically around 60-80 degrees Centigrade. In the example described above, the water in the second step S2 initially has a temperature of 80 degrees Centigrade, although it was heated to boiling point using steam in order to complete the cooking process.

The above embodiments as described are only illustrative, and not intended to limit the technique approaches of the present invention. Although the present invention is described in details referring to the preferable embodiments, those skilled in the art will understand that the technique approaches of the present invention can be modified or equally displaced without departing from the spirit and scope of the technique approaches of the present invention, which will also fall into the protective scope of the claims of the present invention. In the claims, the word “comprising” does not exclude other elements or steps, and the indefinite article “a” or “an” does not exclude a plurality. Any reference signs in the claims should not be construed as limiting the scope.

1. A method of cooking cereal grains, the method comprising:
a first step of subjecting an initial volume of cereal grains in a vessel to hot air having air temperature between 150 to 250° C. for between 30 to 180 seconds to cause the cereal grains to expand above their initial volume, to obtain expanded cereal grains; and
a second step of subjecting the expanded cereal grains to boiling water and/or steam in order to cook the expanded cereal grains for a period of time in the range of 15˜30 minutes; and
wherein the second step is performed subsequent to the first step whilst the expanded cereal grains remain in the vessel.

2. A method according to claim 1, including the step of operating a heater to pre-heat the vessel prior to placing the initial volume of cereal grains in the vessel to perform the first step.

3. A method according to claim 2, including providing water from a reservoir for heating by the heater during the second step.

4. A method according to claim 3, further comprising allowing water that flows from the reservoir for heating by the heater through the vessel and the cereal grains of increased volume contained in the vessel.

5. A method according to claim 3, further comprising allowing water that flows from the reservoir for heating by the heater into the vessel to submerge the cereal grains of increased volume contained in the vessel.

6. A method according to claim 1, wherein the second step comprises subjecting the cereal grains to water having a temperature below boiling point upon commencement of the second step, and heating the water to its boiling point during performance of the second step.

7. A method according to claim 6, wherein the second step comprises subjecting the cereal grains to water that has been pre-heated to a temperature between 60 and 80° C. upon commencement of the second step.

8. A device for cooking cereal grains, the device comprising:
a vessel to receive an initial volume of cereal grains, the vessel being located in a chamber,
a controller,
a reservoir to receive water,
a heater to heat air within the chamber and the water, the heater being controlled by the controller in a first step to expose said initial volume of cereal grains to heated air having an air temperature adapted to cause the cereal grains in the vessel to expand above their initial volume, to obtain expanded cereal grains, and
means, controlled by the controller in a second step to supply water from the reservoir into the chamber, to expose the expanded cereal grains in the vessel to the heated water and/or steam in order to cook the expanded cereal grains for a period of time in the range of 15˜30 minutes.

9. A device according to claim 8, wherein the vessel is located in an elevated position in the chamber, resting on a support.

10. A device according to claim 8, wherein the vessel is fluid-permeable.

11. A device according to claim 8, wherein the vessel is fluid-impermeable.

12. A device according to claim 11, wherein the water supply means comprise a bypass valve to enable at least some of the water to flow directly from the reservoir into the chamber.

13. A device according to claim 10, wherein the device comprises a fan or an air blower for circulating heated air in the chamber 8.

14. A device according to claim 13, wherein the inner walls of the chamber define a food receiving space, the chamber comprises an air circulation channel formed between the outer wall of the vessel and inner wall of the chamber for circulating air in and out the food receiving space of the vessel via said circulation channel.

15. A device according to claim 8, wherein the reservoir surrounds the chamber, and the heater is positioned to allow water contained in the reservoir to be pre-heated by the heater prior to flowing out from the reservoir.
